(19) United States
(12) Patent Application Publication
(10) Pub. No.: US 2008/0279596 A1
(43) Pub. Date: Nov. 13, 2008

(54) LOW GRAININESS PRINTING AND MICR PRINTING WITH SCMB AND EA-SCMB SYSTEMS

(75) Inventors: Michael D. THOMPSON, Rochester, NY (US); John F. KNAPP, Fairport, NY (US); Paul W. MOREHOUSE, JR., Webster, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/746,388

(22) Filed: May 9, 2007

(51) Int. Cl. G03G 15/09

(52) U.S. Cl. 399/267

(57) ABSTRACT

A specific magnet roll design for high speed semi-conductive magnetic brush (SCMB) development systems for magnetic image character recognition (MICR) printing is provided. The resulting magnetic field distributions include a more uniform radial field and enhance solid area development and halftone graininess without or substantially without bead carryout issues. In addition, this enhancement of solid area development enables magnetic toner in these hill speed SCMB systems that normally would not provide sufficient development latitude for MICR.

### BACKGROUND

The exemplary embodiments generally relate to xerographic marking and devices, and specifically relates to semi-conductive magnetic brush (SCMB) development systems, emulsion aggregation-SCMB based systems and magnetic image character recognition (MICR) printing.

Pending U.S. patent application Ser. No. 11/262,575, filed Oct. 31, 2005, by Michael D. Thompson et al., entitled “Xerographic Developer Unit Having Multiple Magnetic Brush Rohls Rotating Against the Photoreceptor,” Attorney Docket No.: 20031548-US-NP, describes how in the process of electrophotographic printing, a charge-retentive surface, also known as a photoreceptor, is charged to a substantially uniform potential, so as to sensitize the surface of the photoreceptor. The charged portion of the photoconductive surface is exposed to a light image of an original document being reproduced, or else a scanned laser image created by the action of digital image data acting on a laser source. The scanning or exposing step records an electrostatic latent image on the photoreceptor corresponding to the informational areas in the document to be printed or copied. After the latent image is recorded on the photoreceptor, the latent image is developed by causing toner particles to adhere electrostatically to the charged areas forming the latent image. This developed image on the photoreceptor is subsequently transferred to a sheet on which the desired image is to be printed. Finally, the toner on the sheet is heated to permanently fuse the toner image to the sheet.

U.S. Pat. No. 4,901,114 discloses an electronic printer employing tri-level xerography to superimpose two images with perfect registration during the single pass of a charge retentive member past the processing stations of the printer. One part of the composite image is formed using MICR toner, while the other part of the image is printed with less expensive black, or color toner. For example, the magnetically readable information on a check is printed with MICR toner and the rest of the check is printed in color or in black toner that is not magnetically readable.

Magnetic image character recognition (MICR) when used in laser printing systems is an important technology for check printing, especially for variable data check applications. Using MICR toners in SCMB-based printers may require more electric bias for the development system (with an attendant modification of the controls system) as well as special toner additives and sometimes carrier conductivity modification to overcome the additional magnetic forces in development. These modifications to the base non-MICR system and developer material add significant cost to the MICR printing process. The magnetic fields used for SCMB systems are typically very high, exacerbating the problem. This added bias limits the print process latitude and can decrease the reliability of the print engine. There is also undesirable structure in the images with MICR toners that precludes their use for both MICR characters and high quality images on checks.

Graininess and mottle in xerographic SCMB images has a component contributed by the magnetic brush structure. This structure comes from the physical structure of the magnetic brush, which causes fluctuations in the electric field during the development process and, although it may be a fairly small effect, it may be a barrier to SCMB systems being used in high quality printing applications.

### SUMMARY

Exemplary embodiments include various aspects of a specific magnet roll design for high speed semi-conductive magnetic brush (SCMB) development systems for magnetic image character recognition (MICR) printing is provided. The resulting magnetic field distributions include a more uniform radial field and enhanced solid area development and halftone graininess without or substantially without bead carryout issues. In addition, this enhancement of solid area development enables magnetic toner in these high speed SCMB systems that normally would not provide sufficient development latitude for MICR.

One aspect is a development system for a printing machine that uses MICR toner particles, including a developer housing, at least one magnetic roll, and a motor. The developer housing retains a quantity of developer. The magnetic roll has a stationary core with at least one magnet and at least one sleeve that rotates about the stationary core of the magnetic roll. The motor is coupled to the magnetic roll to drive the rotating sleeve of the magnetic roll in a direction toward a photoreceptor. The magnetic roll carries the developer through a development zone in a maimer that lowers the magnetic field in a portion of the development zone, facilitating developer transport onto the photoreceptor. The shape of the magnet may be used to lower the magnetic field in the portion of the development zone. A halftone image may be produced. The magnetic field may be lowered substantially at a center of the development zone. A spaced geometry may be used.

Another aspect is a method, wherein quantity of developer is retained having MICR toner particles in a developer housing. At least one sleeve is rotated about a stationary core of at least one magnetic roll. The stationary core has at least one magnet. The rotating sleeve of the magnetic roll is driven by a motor coupled to the magnetic roll in a direction toward a photoreceptor. The magnetic roll carries the developer through a development zone in a manner that lowers the magnetic field in a portion of the development zone, facilitating developer transport onto the photoreceptor. The shape of the magnet may be used to lower the magnetic field in the portion of the development zone. A halftone image may be produced. The magnetic field may be lowered substantially at a center of the development zone. A spaced geometry may be used.

Yet another aspect is a xerographic system, including a feeding unit, a printer unit, an output unit, a developer housing, at least one magnetic roll, and a motor. The feeding unit supplies a plurality of sheets. The printer unit is coupled to the feeding unit and receives the sheets and transfers images onto the sheets. The output unit is coupled to the printer unit and receives the sheets with images. The developer housing in the printer unit retains a quantity of developer having MICR toner particles. The magnetic roll has a stationary core with at least one magnet and at least one sleeve that rotates about the stationary core of the magnetic roll. The motor is coupled to the magnetic roll to drive the rotating sleeve of the magnetic roll in a direction toward a photoreceptor. The magnetic roll carries the developer through a development zone in a manner that lowers the magnetic field in a portion of the development zone, facilitating developer transport onto the photoreceptor. The shape of the magnet may be used to lower the magnetic field in the portion of the development zone. A halftone image may be produced. The magnetic field may be lowered substantially at a center of the development zone. A spaced geometry may be used. A region pre- and post-development zone may maintain material transport. A halftone dot size may be normalized around a predetermined area. The visual noise may be below a predetermined threshold. The portion of the magnetic field may be about 50 degrees of rotational position or about 25 degrees clockwise to about 25 degrees counterclockwise relative to a line defining a center of the development zone.

### BRIEF DESCRIPTION OF THE DRAWINGS

FIG. 1 illustrates an elevational view of an electrostatographic printing apparatus in the related art;

FIG. 2 illustrates the overall function of a developer unit in the related art;

FIG. 3 illustrates a schematic of various components of an electrophotographic printing machine in the related art;

FIG. 4 illustrates a typical response when a MICR toner is used with a standard SCMB development system;

FIG. 5 illustrates MICR development behavior according to exemplary embodiments;

FIGS. 6A and 6B illustrate differences between MICR and non-MICR toners;

FIGS. 7A and 7B illustrate halftone dot size distribution with and without exemplary embodiments;

FIG. 8 illustrates visual noise reduction achieved in experimental testing with exemplary embodiments; and

FIGS. 9A and 9B illustrate a tangential magnetic field and a radial magnetic field in a development zone for exemplary embodiments.

### DETAILED DESCRIPTION OF EMBODIMENTS

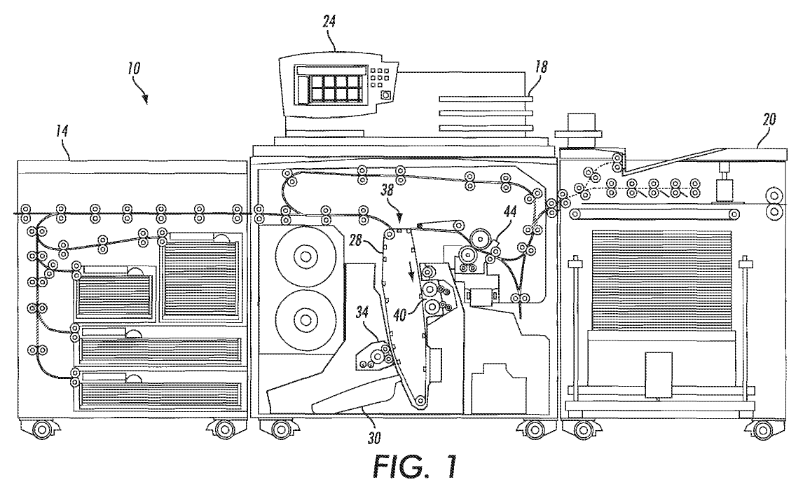

FIG. 1 is an elevational view of an electrostatographic printing apparatus 10 in the related art, such as a printer or copier, having a development subsystem that uses two magnetic rolls for developing toner particles that are carried on semiconductive carrier particles. Such toner particles and carrier particles are one type of developer material among many types. One embodiment includes single component developers in which there is no carrier, where the toner itself is magnetic and is transported similarly to two component systems. One embodiment includes semi-conductive magnetic brush development (a two component technology while another embodiment includes single component technology.

One related art type of development of an electrostatic image is called “two-component development”. Two-component developer material generally includes toner particles interspersed with carrier particles. The carrier particles are magnetically attractable, and the toner particles are caused to adhere triboelectrically to the carrier particles. This two-component developer can be conveyed, by means such as a “magnetic roll,” to the electrostatic latent image, where toner particles become detached from the carrier particles and adhere to the electrostatic latent image.

In magnetic roll development systems, the carrier particles with the triboelectrically adhered toner particles are transported by the magnetic rolls through a development zone. The development zone is the area between the outside surface of a magnetic roll and the photoreceptor surface on which a latent image has been formed. Because the carrier particles are attracted to the magnetic roll, some of the toner particles are interposed between a carrier particle and the latent image on the photoreceptor. These toner particles are attracted to the latent image and transfer from the carrier particles to the latent image. The carrier particles are removed from the development zone as they continue to follow the rotating surface of the magnetic roll. The carrier particles then fall from the magnetic roll and return to the developer supply where they attract more toner particles and are reused in the development process. The carrier particles fall from the magnetic roll under the effects of gravity or are directed away from the roller surface by a magnetic field.

Different types of carrier particles can be used to enhance the development of toner from two-component developer with magnetic roll development systems. One type of carrier particle is a very electrically insulated carrier and development systems using developer having these carrier particles typically develop lines and fine detail with high fidelity. Development efficiency for solid areas, however, is increased through low magnetic field agitation in the development zone along with close spacing to the latent image and elongation of the development zone. The magnetic field agitation helps reduce or prevent electric field collapse caused by toner countercharge in the development zone. The close spacing increases the effective electric field for a potential difference and the longer development zone provides more time for toner development.

Another type of carrier particle used in two-component developers is an electrically conductive carrier particle. Developers using this type of carrier particle are capable of being used in magnetic roll systems that produce toner bearing substrates at speeds of up to approximately 100 pages per minute (ppm). These developers typically recruit toner for the latent electrostatic image from areas near the tip of the developer magnetic brush that are proximate the surface of the photoconductor because the electric fields are high in this region. The electrical conductivity of the carrier particles serves to reduce or prevent development field collapse caused by the retention of toner countercharge and thereby allows high efficiency development, especially of solid area latent images.

Another type of carrier particle used in two-component developers is the semiconductive carrier particle. Developers using this type of carrier particle are also capable of being used in magnetic roll systems that produce toner bearing substrates at speeds of up to approximately 200 pages per minute (ppm). Developers having semiconductive carrier particles use a relatively thin layer of developer on the magnetic roll in the development zone. This feature allows more of the toner to be recruited during development than thick brush conductive developers allow. In these systems, an AC electric waveform is typically applied to the magnetic roller to cause the developer to become electrically conductive during the development process. The electrically conductive developer increases the efficiency of development by reducing or preventing development field collapse due to countercharge left in the magnetic brush by the developed toner. A typical waveform applied to these systems is, for example, a square wave at a peak to peak amplitude of 1000 Volts and a frequency of 9 KHz. This waveform controls both the toner movement and the electric fields in the development zone.

The electrostatographic printing apparatus 10 of FIG. 1 has a development subsystem that uses two magnetic rolls for developing toner particles that are carried on semiconductive carrier particles. The machine 10 includes a feeder unit 14, a printing unit 18, and an output unit 20. The feeder unit 14 houses supplies of media sheets and substrates onto which document images are transferred by the printing unit 18. Sheets to which images have been fixed are delivered to the output unit 20 for correlating and/or stacking in trays for pickup.

The printing unit 18 includes an operator console 24 where job tickets may be reviewed and/,or modified for print jobs performed by the machine 10. The pages to be printed during a print job may be scanned by the printing machine 10 or received over an electrical communication link. The page images are used to generate bit data that are provided to a raster output scanner (ROS) 30 for forming a latent image on the photoreceptor 28. Photoreceptor 28 continuously travels the circuit depicted in FIG. 1 in the direction indicated by the arrow. The development subsystem 34 develops toner on the photoreceptor 28. At the transfer station 38, the toner conforming to the latent image is transferred to the substrate by electric fields generated by the transfer station. The substrate bearing the toner image travels to the fuser station 44 where the toner image is fixed to the substrate. The substrate is then carried to the output unit 20.

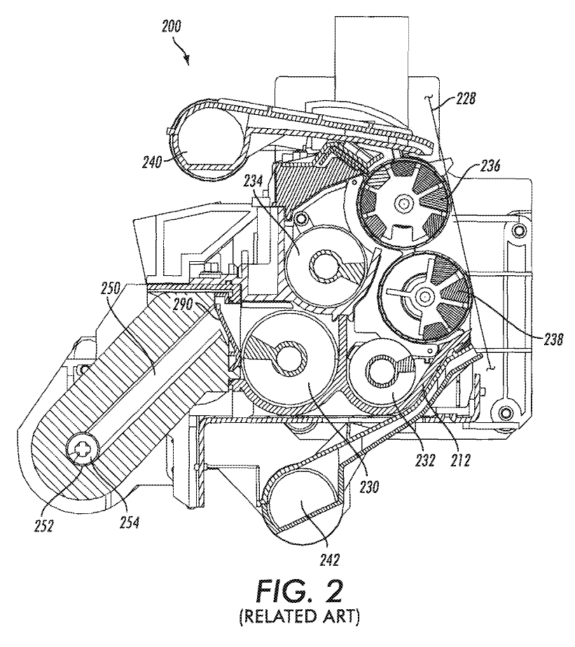

FIG. 2 shows the overall function of a developer unit 200, which is to apply marking material, such as toner, onto suitably-charged areas forming a latent image on an image receptor such as the photoreceptor 228, in a manner generally known in the art. The developer unit 200, however, provides a longer development zone while maintaining an adequate supply of developer having semiconductive carrier particles than many other development systems. Various types of printers can include multiple such developer units 200, such as one for each primary color or other purpose. For example, MICR development may be performed in tandem with color development,

Among the elements of the developer unit 200, which is shown in FIG. 2, are a housing 212, which functions generally to hold a supply of developer material having semiconductive carrier particles, as well as augers, such as 230, 232, 234, which variously mix and convey the developer material, and magnetic rolls 236, 238, which in this embodiment form magnetic brushes to apply developer material to the photoreceptor 228. Other types of features for development of latent images, such as donor rolls, paddles, scavengeless-development electrodes, commutators, etc., are known in the art. FIG. 2 also shows air manifolds 240, 242, attached to vacuum sources (not shown) for removing dirt and excess particles from the transfer zone near photoreceptor 228. As mentioned above, a two-component developer material is comprised of toner and carrier. The carrier particles in a two-component developer are generally not applied to the photoreceptor 228, but rather remain circulating within the housing 212. The augers 230, 232, and 234 are configured and cooperate in a manner described in U.S. patent application Ser. No. 11/263,370 filed Oct. 31, 2005 by Steven C. Hart et al, entitled “Variable Pitch Auger To Improve Pickup Latitude In Developer Housing,” Attorney Docket No. 20041346, and U.S. patent application Ser. No. 11/263,371 filed Oct. 31, 2005 by Steven C. Hart et al., entitled “Developer Housing Design With Improved Sump Mass Variation Latitude,” Attorney Docket No. 20041120.

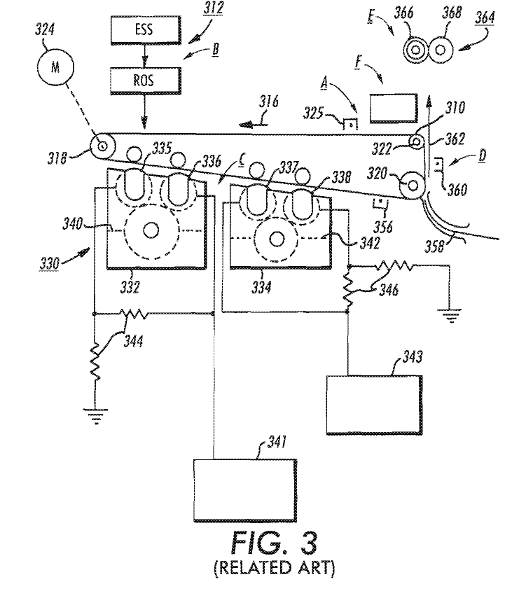

FIG. 3 schematically depicts the various components of an illustrative electrophotographic printing machine disclosed in U.S. Pat. No. 4,901,114. As shown in FIG. 3, the printing machine utilizes a photoconductive belt 310, which includes of a photoconductive surface and an electrically conductive substrate. Belt 310 moves in the direction of arrow 316 to advance successive portions thereof sequentially through the various processing stations disposed about the path of movement thereof. Belt 310 is entrained about a plurality of rollers 318, 320 and 322, the former of which can be used as a drive roller and the latter of which can be used to provide suitable tensioning of the photoreceptor belt 310. Motor 324 rotates roller 318 to advance belt 310 in the direction of arrow 316. Roller 318 is coupled to motor 324 by suitable means, such as a belt drive.

As can be seen by further reference to FIG. 3, initially a portion of belt 310 passes through charging station A. At charging station A, a corona discharge device such as a scorotron or corotron indicated generally by the reference numeral 325, charges the belt 310 to a selectively high uniform positive or negative potential,

Next, the charged portion of the photoreceptor surface is advanced through exposure station B. At exposure station B, the uniformly charged photoreceptor or charge retentive surface 310 is exposed to a laser based input and/or output scanning device 312, which causes the charge retentive surface to be discharged in accordance with the output from the scanning device. Preferably, the scanning device is a three level raster output scanning device.

The photoreceptor 310 which is initially charged to a voltage V₀, undergoes dark decay to a level V_{ddp}. When exposed at the exposure station B it is discharged to V_{w} imagewise in the background (white) image areas and to V_{c} which is near zero or ground potential in the highlight (i.e. color other than black) color parts of the image.

At development station C, a magnetic brush development system, indicated generally by the reference numeral 330 advances developer materials into contact with the electrostatic latent images. The development system 330 includes first and second developer housings 332 and 334. Preferably, each magnetic brush development housing includes a pair of magnetic brush developer rollers. Thus, the housing 332 contains a pair of rollers 335, 336 while the housing 334 contains a pair of magnetic brush rollers 337, 338. Each pair of rollers advances its respective developer material into contact with the latent image. Each developer roller pair forms brush structure comprising toner particles which are attracted by the latent images on the photoreceptor.

Color discrimination in the development of the electrostatic latent image is achieved by passing the photoreceptor past the two developer housings in a single pass with the magnetic brush rolls electrically biased to voltages which are offset from the background voltage V_{w}, the direction of offset depending on the toner in the housing. One housing, e.g. 332 (for the sake of illustration, the first), contains developer with black toner 340 having triboelectric properties such that the toner is driven to the most highly charged (V_{ddp}) areas of the latent image by the electrostatic field (development field) between the photoreceptor and the development rolls biased at V_{bb1} and V_{bb2} (V black biases). Conversely, the triboelectric charge on colored toner 342 in the second housing is chosen so that the toner is urged towards parts of the latent image at residual potential, V_{c} by the electrostatic field (development field) existing between the photoreceptor and the development rolls in the second housing at bias voltages V_{cb1} and V_{cb2} (V color biases).

In prior art or related art tri-level xerography, the entire photoreceptor voltage difference (|V_{ddp}−V_{c}|) is shared equally between the charged area development (CAD) and the discharged area development (DAD). This corresponds to apprxeq 600 volts (if a realistic photoreceptor value for V_{ddp} of 700 volts and a residual discharge voltage of 100 volts are assumed). Allowing an additional 100 volts for the cleaning field in each development housing (|V_{bb}−V_{white}| or |V_{white}−V_{cb}|) means an actual development contrast voltage for CAD of approximately 200 volts and an approximrately equal amount for DAD. In the foregoing case, the 200 volts of contrast voltage is provided by electrically biasing the first developer housing to a voltage level of approximately 500 volts and the second developer housings to a voltage level of 300 volts. Although 200 volts contrast is generally sufficient, 250 volts is more desirable in practice to assure adequate system latitude as the developers age.

Accordingly, a more desirable development field is provided with the first developer housing by biasing the roller 335 to a voltage level (V_{bb1}) equal to 450 volts which provides 250 (|V_{adp}−V_{bb}|) or (700−450=250) volts for the development field. An added advantage of this increased development field is that the reverse development field is reduced by the magnitude of such increase, therefore, there is less tendency for induction charging to reverse the polarity of the charge on the black toner and cause it to be attracted to the red latent image. The reverse development field is that field which is established between the developer rollers and the colored image areas. The bias on the roller 36 in the first housing is 500 volts, consequently, the increased development seen with the roller 335 is not present with the roller 336. However, the cleaning field (|V_{bb2}−V_{w}) is twice that of the field established between roller 335 and the photoreceptor in the V_{w} areas. The bias, V_{cb1} on the roller 336 is 350 volts thereby providing 250 volts for the development field between the roller 337 and the colored image areas of the photoreceptor. The bias, V_{cb2} on the roller 338 is 300 volts thereby providing only a 200 volt development field but a larger cleaning as in the case of the roller 36.

The foregoing developer biases are provided by power supplies 341 and 343. These power supplies are each provided with suitable resistor pairs 344 and 346 for providing the different biases to the rolls 335, 336, 337 and 338.

In FIG. 3, the housing 332 contains black MICR type developer. The housing 334 preferably contains a magnetic developer whose magnetic component is reduced such that it is not readable by MICR devices. Alternatively, the developer in the housing 334 may be non-magnetic. While the developers in FIG. 3 are different colors, they may also be the same color.

A sheet of support material 358 is moved into contact with the toner image at transfer station D). The sheet of support material is advanced to transfer station D by conventional sheet feeding apparatus, not shown. Preferably, sheet feeding apparatus includes a feed roll contacting the uppermost sheet of a stack copy sheets. Feed rolls rotate so as to advance the uppermost sheet from stack into a chute which directs the advancing sheet of support material into contact with photoconductive surface of belt 310 in a timed sequence so that the toner powder image developed thereon contacts the advancing sheet of support material at transfer station D.

Because the composite image developed on the photoreceptor consists of both positive and negative toner, a pre-transfer corona discharge member 356 is provided to condition the toner for effective transfer to a substrate using corona discharge.

Transfer station D includes a corona generating device 360 which sprays ions of a suitable polarity onto the backside of sheet 358. This attracts the charged toner powder images from the belt 310 to sheet 358. After transfer, the sheet continues to move, in the direction of arrow 362, onto a conveyor (not shown), which advances the sheet to fusing station E.

Fusing station E includes a fuser assembly, indicated generally by the reference numeral 364, which permanently affixes the transferred powder image to sheet 358. Preferably, fuser assembly 364 comprises a heated fuser roller 366 and a back-up roller 368. Sheet 358 passes between fuser roller 366 and back-up roller 368 with the toner powder image contacting f-user roller 366. In this manner, the toner powder image is permanently affixed to sheet 358. After fusing, a chute, not shown, guides the advancing sheet 358 to a catch tray, also not shown, for subsequent removal from the printing machine by the operator.

After the sheet of support material is separated from photoconductive surface of belt 310, the residual toner particles carried by the non-image areas on the photoconductive surface are removed therefrom. These particles are removed at cleaning station F.

Subsequent to cleaning, a discharge lamp (not shown) floods the photoconductive surface with light to dissipate any residual electrostatic charge remaining prior to the charging thereof for the successive imaging cycle.

Turning now to the present invention, exemplary embodiments include tailoring a magnetic field in a development zone of a modern SCMB magnetic brush development system such that the structure of the brush is changed in such a way as to preserve the normal transport characteristics of the magnetic developer material and, at the same time, to reduce the magnetically induced structure in the development zone. Exemplary embodiments include a special magnetic field patterning in the development zone for a SCMB system. This magnetic field patterning reduces magnetic brush induced image noise for standard and MICR toners as well as reducing the magnetic holding forces in the nip for MICR toners thereby allowing MICR toners to develop at reduced electric fields, increasing the latitude of the system and reducing or eliminating the necessity for drastic changes in developer material for MICR electrophotographic printing systems compared to non-MICR systems.

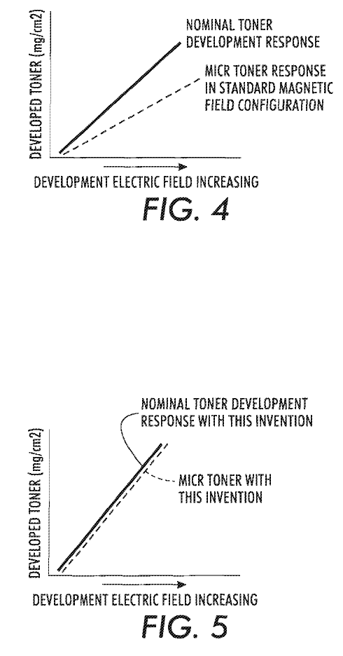

Typical contemporary SCMB-based development systems are at the heart of many color electrophotographic systems. These systems are characterized by a magnetic development roll with high magnetic fields, typically 800-1200 g at the roll surface in the development zone. The solid area development response is relevant to the behavior of the system and for the control system design. Magnetic brash development needs a certain electrostatic field to strip toner from the developer beads and present the toner to a latent electrostatic image, as indicated in FIG. 4.

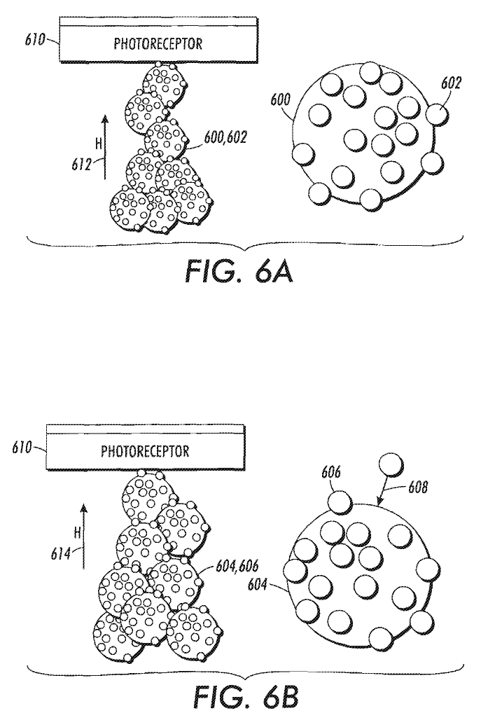

FIG. 4 shows a typical response when a MICR toner is used with a standard SCMB development system, i.e., reduced development response for equivalent development electric field. The source of this problem is illustrated in FIGS. 6A and 6B, which show the increased adhesion of MICR toner to magnetic carrier in an external magnetic field.

FIG. 5 shows results produced by one exemplary embodiment, which increase the development response for MICR toner and makes the performance similar to that of standard toner for similar toner charge to mass ratios, reducing the need for special charging additives and conductivity modification of MICR developer.

Graininess and mottle in xerographic SCMB images has a component contributed by the magnetic brush structure. This structure comes from fluctuations in the electric field during the development process and, although it may be a fairly small effect, it may be a barrier to these systems being used in high quality printing applications. The approach used in exemplary embodiments for enhancing MICR capability with SCMB also improves development with standard toners by reducing magnetic brash structure in the development zone

FIGS. 6A and 6B show differences between MICR and non-MICR toners. FIG. 6A shows an exemplary non-MICR toner, while FIG. 6B shows an exemplary MICR toner.

With the normal SCMB development of FIG. 6A, development brush electrostatic forces and short range adhesion forces exist between the carrier beads 600 and toners 602.

With the MICR SCMB development of FIG. 6B, brush electrostatic forces and short range adhesion forces exist between the carrier beads 604 and toners 606 plus an added magnetic adhesion force 608. This added magnetic adhesion force may be expressed as the following equation.

\dot{F}ₘ∝∇(mₜ·\dot{B})

where Fₘ is the magnetic force between the toners 606 and carriers 604, mₜ is the magnetic moment of toner, and B is the field around the carrier bead 604 caused by the response of beads 604 to external magnetic field H. Because MICR toners have magnetic material in them and the magnetic brush already has a magnetic field in it, the toner tends to stick tighter to the carrier so that the movement of the toner toward the photoreceptor is more difficult.

In FIG. 6A, carrier 600 and toner 602 particles are on top of a magnetic brush or roller (not shown) moving towards a photoreceptor 610. A magnetic component (H) 612 holds the carrier particles 600 with electrostatically attached toner particles 602, to the roll surface as they move into the vicinity of the photoreceptor 610.

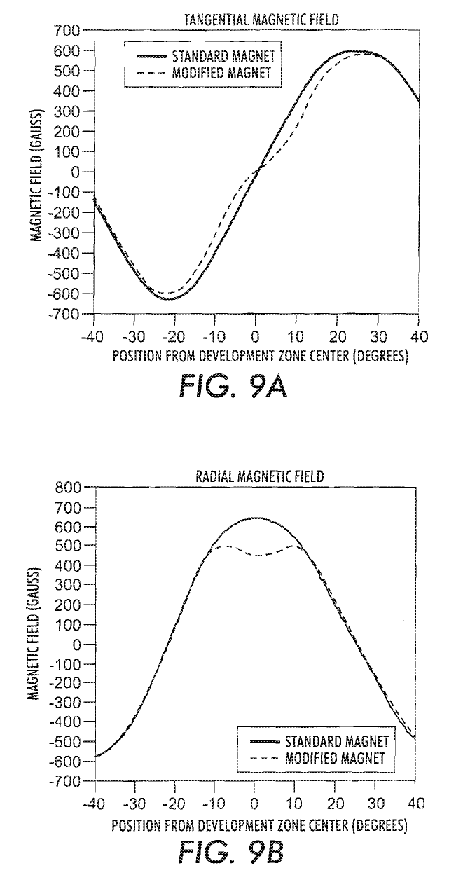

In FIG. 6B, carrier 604 and MICR toner 606 particles are on top of a magnetic brush or roller (not shown) moving towards a photoreceptor 610. A magnetic field (H) 614 holds the carrier particles 604 with electrostatically and magnetostatically attached MICR toner particles 606, to the roll surface as they move into the vicinity of the photoreceptor 610. The MICR toner 606 and carrier particles 604 have both electrostatic and magnetic forces adhering them together because the toner 606 is magnetic. Thus, it is harder for the particles to move off the magnetic brush and onto the photoreceptor 610. Exemplary embodiments reduce the magnetic field to allow this to occur more easily. Exemplary embodiments change the magnetic field in a way according to FIGS. 9A and 9B by, for example, changing the shape of at least one magnet. Other embodiments include lowering the magnetic field in other ways, such as using a different magnet material in the appropriate region. More electrostatic bias is needed to break apart the particles, if the force increases between the toner and the carrier beads. Lowering the magnetic field in a portion of the development zone in the way indicated in FIGS. 9A and 9B not only reduces the stickiness of the particles for MICR toner in FIG. 6B, but also improves image quality by reducing graininess and noise for non-MICR toner.

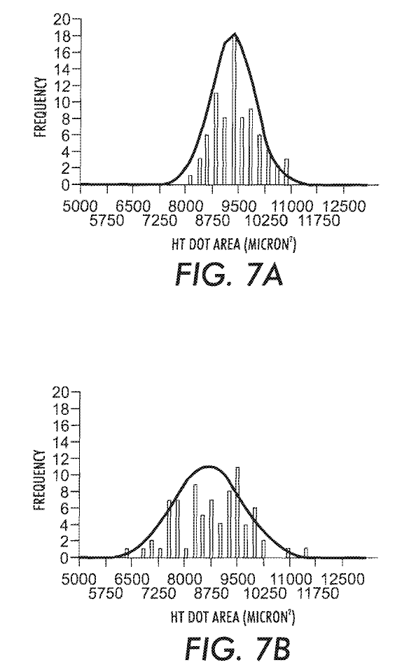

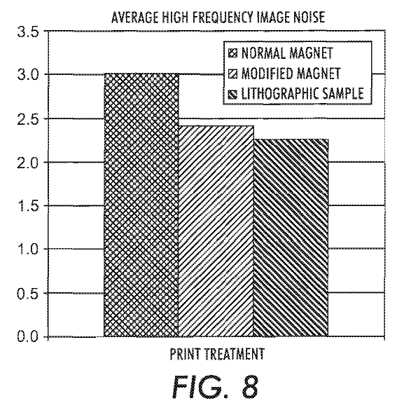

FIGS. 7A, 7B and 8 show enhancements in the halftone dot size variation and image noise with exemplary embodiments compared to related art. FIGS. 7A and 7B show that the effect of the modified magnet is to lowers the magnetic field and thereby to enhance development as well as enhance halftone image quality. FIG. 8 shows a reduction in image noise using the modified magnetics.

FIGS. 9A and 9B illustrate an exemplary embodiment of a magnetic field pattern. FIG. 9A shows the tangential magnetic field, while FIG. 9B shows the radial magnetic field. The tangential magnetic field of FIG. 9A defines a maximum position of the change. The radial position only shows a change from −15 to +15 degrees, but consider the sum of the radial and tangential magnetic fields. Both figures show curves for a standard magnet and a magnet modified according to exemplary embodiments. The lobes in the radial field (FIG. 9B) and slight twist in the tangential field (FIG. 9A) allow developer transport through the development zone. The lower magnetic field of the modified magnet reduces magnetic forces between MICR toner and carrier in the development zone. Simply lowering the magnetic field throughout the development zone would not be sufficient in a spaced development zone configuration, such as that in FIGS. 9A and 9B because the developer would not move through the development zone correctly.

Together FIGS. 9A and 9B illustrate the altered magnetic field vector (i.e., magnitude and direction). The special magnetic field patterning in these figures provides enhanced development and enhanced halftone image quality. The curve for the modified magnet in the development zone (i.e., from about −40 degrees to about 40 degrees in this example) is altered.

A magnet at the center of the development zone is modified in exemplary embodiments, leaving two regions pre- and post-nip to maintain material transport. This is different from Haze-type development (i.e., low magnetic field zones; see U.S. Pat. No. 4,394,429) in that exemplary embodiments modify the field in only a portion of the development zone and rely on a wrapped geometry to contain the developer particles. This approach used here enables the use of a spaced geometry that is typical for SCMB systems. Prior testing demonstrated the need for two rollers with MICR in SCMB; however, exemplary embodiments may allow a single developer roll for high speed applications. Experimental testing demonstrated low noise and that MICR toners need more development potential applied with SCMB. Thus, MICR printers may print pictorials that require low noise. One exemplary embodiment is a machine using MICR in a print engine that uses SCMB. Another exemplary embodiment is a method for allowing small engines to print high quality output and use MICR.

It will be appreciated that various of the above-disclosed and other features and functions, or alternatives thereof, may be desirably combined into many other different systems or applications. Also, various presently unforeseen or subsequently made by those skilled in the art, and are also intended to be encompassed by the following claims.

What is claimed is:

1. A development system for a printing machine that uses MICR toner particles, comprising:
a developer housing for retaining a quantity of the developer;
at least one magnetic roll having a stationary core with at least one magnet and at least one sleeve that rotates about the stationary core of the magnetic roll; and
a motor coupled to the magnetic roll to drive the rotating sleeve of the magnetic roll in a direction toward a photoreceptor;
wherein the magnetic roll carries the developer through a development zone in a manner that lowers the magnetic field in a portion of the development zone, facilitating developer transport onto the photoreceptor.

2. The development system of claim 1, wherein a shape of the magnet is used to lower the magnetic field in the portion of the development zone.

3. The development system of claim 1, wherein a halftone image is produced.

4. The development system of claim 1, wherein the magnetic field is lowered substantially at a center of the development zone.

5. The development system of claim 1, wherein a spaced geometry is used.

6. A method of developing, comprising:
retaining a quantity of developer having MICR toner particles in a developer housing;
rotating at least one sleeve about a stationary core of at least one magnetic roll, the stationary core having at least one magnet; and
driving the rotating sleeve of the magnetic roll by a motor coupled to the magnetic roll in a direction toward a photoreceptor;
wherein the magnetic roil carries the developer through a development zone in a manner that lowers the magnetic field in a portion of the development zone, facilitating developer transport onto the photoreceptor.

7. The method of claim 6, further including using a shape of the magnet to lower the magnetic field in the portion of the development zone.

8. The method of claim 6, further including producing a halftone image.

9. The method of claim 6, further including lowering the magnetic field substantially at a center of the development zone.

10. The method of claim 6, further including using a spaced geometry.

11. A xerographic system, comprising:
a feeding unit for supplying a plurality of sheets;
a printer unit coupled to the feeding unit for receiving the sheets and transferring a plurality of images onto the sheets;
an output unit coupled to the printer unit for receiving the sheets with images;
a developer housing in the printer unit for retaining a quantity of developer having MICR toner particles;
at least one magnetic roll having a stationary core with at least one magnet and at least one sleeve that rotates about the stationary core of the magnetic roll; and
a motor coupled to the magnetic roll to drive the rotating sleeve of the magnetic roll in a direction toward a photoreceptor;
wherein the magnetic roll carries the developer through a development zone in a manner that lowers the magnetic field in a portion of the development zone, facilitating developer transport onto the photoreceptor.

12. The xerographic system of claim 11, wherein a shape of the magnet is used to lower the magnetic field in the portion of the development zone.

13. The xerographic system of claim 11, wherein a halftone image is produced.

14. The xerographic system of claim 11, wherein the magnetic field is lowered substantially at a center of the development zone.

15. The xerographic system of claim 11, wherein a spaced geometry is used.

16. The xerographic system of claim 11, wherein a region pre- and post-development zone maintain material transport.

17. The xerographic system of claim 11, wherein a halftone dot size is normalized around a predetermined area.

18. The xerographic system of claim 11, wherein visual noise is below a predetermined threshold.

19. The xerographic system of claim 11, wherein the portion of the magnetic field is about 50 degrees of rotational position.

20. The xerographic system of claim 11, wherein the portion of the magnetic field is about 25 degrees clockwise to about 25 degrees counterclockwise relative to a line defining a center of the development zone.
